(19) United States
(12) Patent Application Publication
(10) Pub. No.: US 2015/0286948 A1
(43) Pub. Date: Oct. 8, 2015

(54) OCCUPANCY DETECTION METHOD AND SYSTEM

(71) Applicant: KONINKLIJKE PHILIPS N.V., Eindhoven (NL)

(72) Inventors: Tiberi Luca, Eindhoven (NL); Ingrid Christina Marie Flinsenberg, Eindhoven (NL); Bahaa Eddine Sarroukh, Helmond (NL); Andre Barroso, Aachen (DE)

(21) Appl. No.: 14/436,619

(22) PCT Filed: Oct. 8, 2013
(86) PCT No.: PCT/IB2013/059205

§ 371 Date: Apr. 17, 2015

Related U.S. Application Data
(60) Provisional application No. 61/714,832, filed on Oct. 17, 2012.

(51) Int. Cl. G06N 5/04; G05B 15/02; H05B 37/02; F24F 11/00

(52) U.S. Cl. CPC G06N 5/047; F24F 11/006; G05B 15/02; H05B 37/0218

(57) ABSTRACT

The present invention relates generally to the field of occupancy detection, and more particularly to an occupancy detection system and a corresponding method suitable for a presence controlled system. A method and system for determining occupancy of a room is provided, in which a signal from a movement sensor positioned in the room is analyzed to detect variations in the signal which correspond to movements of an occupant of the room. The room is determined to be empty if in the received signal a leave pattern is identified. The leave pattern is a predetermined pattern which has been associated with an occupant leaving the room. The method and system provide reliable occupancy detection in more or less static environments like for instance offices, and when utilized in for instance a presence controlled lighting system, the number of frustrating erroneous “switch-off” events of the light in a situation where a room is still occupied by occupants involved in relative still/static activities is then decreased.

### FIELD OF THE INVENTION

The present invention relates generally to the field of occupancy detection, and more particularly to an occupancy detection system and a corresponding method suitable for a presence controlled system.

### BACKGROUND OF THE INVENTION

Control systems for automatically control lighting and ventilation systems, or heating, ventilation, and air condition systems (HVAC), often rely on occupancy detectors to maximize correct, efficient and timely delivery of light and air in the environment. A main concern of occupancy detectors for lighting control in such presence or occupancy controlled systems is to ensure that lighting is promptly switched on when a person enters a given environment. Cheap and efficient solutions to deliver on this goal consist of Passive Infrared Sensors (PIR), RADARs or SONARs. These are able of quickly detecting movements in the environment while respecting privacy (as opposed to cameras). Their limitation lies however in the lack of sensitivity to small movements. In office environments where workers can remain largely immobile for large periods or time, e.g. reading, typing, etc., these sensors may erroneously signal an empty room to the control system. This is due to the fact that such sensors signal an empty room after no movement has been recorded over the last period, the duration of that period which can usually be set by the user. This error is very disruptive and frustrating when lighting is mistakenly switched off. Correcting this inaccuracy without adding unnecessary long delays to a switch-off command in case of empty room would enable systems that are at the same time energy-efficient and correct.

US Patent Application Pub. No US 2010/088218 A1, Jul. 29, 2010 discloses a system to detect occupancy in a space including a detector to identify when an occupancy was last detected in the space, and a sensor to issue a signal at an instance when a door to the space closes. The system is arranged to identify when the door closes based on the signal from the detector and to judge the space to be unoccupied after a wait time if the signal indicates that occupancy was last detected prior to the closing. A downside to this system is the need for two types of sensors, which require installation and maintenance, besides their unit cost.

### SUMMARY OF THE INVENTION

It is an object of the present invention to provide an alternative and improved method and system for determining occupancy of a room. Further, it would be advantageous to achieve reliable occupancy detection in more or less static environments like for instance offices that only requires one type of sensor. It would also be desirable to provide reliable occupancy detection for which events of erroneously determining the room as “empty” is minimized.

To better address one or more of these concerns, a method and system for occupancy detection according to the present invention as defined in the appended independent claim is presented. Preferred embodiments are set forth in the dependent claims and in the following description and drawings.

According to a first aspect of the invention, there is provided a method of determining occupancy of a room, the method comprising: receiving a signal from at least one movement sensor positioned in the room, detecting variations in the signal which correspond to movements of an occupant of the room, analyzing the detected variations in order to identify one or more patterns therein, and determining that the room is empty if the one or more patterns comprises a leave pattern associated with an occupant leaving the room.

Herein, ‘pattern’ does not necessarily imply that the detected variations are in a specific order. For example, in a binary signal wherein the detected variations are transitions from a logic-1 to a logic-0 or vice versa, a predetermined number of logic-1's in a given amount of time may be deemed a leave pattern. In an embodiment, the type and order of the detect variations is taken into account when identifying one or more patterns therein, and/or when determining that the one or more patterns comprises a leave pattern.

Advantageously, the occupancy detection according to the present method may be based solely on the signal output of a single motion sensor. Further, increased reliability in the occupancy detection is provided by detecting the leave pattern in the outputted signal of the movement sensor. This decreases erroneous signaling that the room is empty even at times when the occupant does not move but is still present in the room. When utilized in for instance a presence controlled lighting system, this in turn will decrease frustrating erroneous “switch-off” events of the light in a situation where a room is still occupied by occupants involved in relative still/static activities. The same advantage is applicable to HVAC systems which operate based on room occupancy.

According to an embodiment of the method, the leave pattern is based on detecting a minimum amount of movement within a predetermined maximum time period. According to an embodiment of the method, the minimum amount of movement is based on detecting a minimum number of consecutive signal rising or falling edges within the maximum time period, or based on detecting a minimum amount of time when the signal indicates movement within the maximum time period.

According to an embodiment, the method further comprises setting an occupancy state of the room based on at least one of a first delay after which the occupancy state is set to ‘empty’ if no movement is detected after the leave pattern is detected, and a second delay after which the occupancy state is set to ‘empty’ if no movement is detected after a last detected movement in the room.

According to an embodiment, the method further comprises detecting any switch of the occupancy state from an occupied state ‘occupied’, to and an empty state ‘empty’, and for each switch detected over time: recording at least one occupancy detection parameter related to the switch of the occupancy state, and processing the at least one occupancy detection parameter in order to reduce the probability of failure of the method for detecting occupancy.

This advantageously enables optimization of the settings of the occupancy detection parameters based on historic data collected by the occupancy sensor. Thereby, the need for a user to manually set the occupancy detection parameters is eliminated, while automatic/controlled tuning of the parameter so as to further minimize the occurrence of lights switching off when a person sits still at his/her desk for a long period. Further, fine tuning of the occupancy detection method to the specific case, i.e. to a specific building, different occupancy patterns of a room over time etc., is enabled, leading to maximized energy savings and increased customer satisfaction. The controlled tuning is based on the data collected continuously during the usage of the presence detection system for energy saving lighting and ventilation control.

According to a second aspect of the invention, there is provided an occupancy detection system comprising at least one movement sensor for providing a signal corresponding to movements of at least one occupant of a room, an occupancy estimator operably connected to the at least one movement sensor for providing an occupancy state based on the signal, and an output operably connected to the occupancy estimator to communicate the occupancy state generated by the occupancy estimator. The occupancy estimator is arranged for analyzing variations in the signal in order to identify one or more patterns therein, and setting the occupancy state to indicate a room monitored by the at least one movement sensor to ‘empty’ based on identifying that the one or more patterns comprises a leave pattern associated with an occupant leaving the room. The occupancy detection system generally has the same advantages as describe above for the occupancy detection method.

According to an embodiment, the occupancy detection system comprises an input operably connected to the occupancy estimator for receiving occupancy detection parameters associated with the leave pattern and/or the setting of the occupancy state from a user input or an external data base.

According to an embodiment, the occupancy detection system further comprises storage means for recording the occupancy state and signal over time. The occupancy estimator is further arranged for controlling occupancy detection parameters by detecting any switch of the occupancy state from an occupied state ‘occupied’, to and an empty state ‘empty’, and for each switch detected over time: recording at least one occupancy detection parameter related to the switch of the occupancy state, and processing the at least one occupancy detection parameter in order to reduce the probability of failure of the method for detecting occupancy.

An occupancy detection system according to the present inventive concept, may advantageously be included in a lighting system comprising at least one light source, and a lighting controller for controlling the at least one light source based on the occupancy state provided by the occupancy detection system.

Further, an occupancy detection system according to the present inventive concept, may advantageously be included in a HVAC system comprising at least one HVAC unit, and a HVAC controller for controlling the at least one HVAC unit based on the occupancy state provided by the occupancy detection system.

The occupancy detection method and system according to the present invention advantageously provide accurate information regarding the occupancy state of a room, which as mentioned above is applicable in for instance presence controlled lighting and/or ventilation control in highly static environments. By implementing the occupancy detection method or system in these presence controlled systems, improvement of the overall performance of these systems can be achieved. The occupancy detection system allows the use of a lower delay time between determining a room to be empty before the lights are shut down which may decrease the energy consumption of the presence controlled system, while still preventing frustrating events when the lights switch off when a person sits still at his/her desk for a long period. It also enables ventilation control to achieve faster decision times in reducing air inflow to an empty room. The result is higher energy saving with increased customer satisfaction.

These and other aspects, features, and advantages of the invention will be apparent from and elucidated with reference to the embodiments described hereinafter.

### BRIEF DESCRIPTION OF THE DRAWINGS

The invention will now be described in more detail and with reference to the appended drawings in which:

FIG. 1 is a schematic view of a room comprising an embodiment of an occupancy detection system according to the present invention;

FIG. 2 is a schematic illustration of an embodiment of an occupancy detection system according to the present invention; and

FIG. 3 is a flow chart illustrating an embodiment of a method for determining the occupancy of a room according the present invention.

### DETAILED DESCRIPTION OF EMBODIMENTS

The present invention will now be described more fully hereinafter with reference to the accompanying drawings. The below embodiments are provided by way of example so that this disclosure will be thorough and complete, and will fully convey the scope of the invention to those skilled in the art. Like numbers refer to like elements throughout.

The current inventive concept is applicable for any presence controlled system of a room or building, e.g. lighting systems, or heating ventilation and air condition systems (HVAC), or some combination thereof. For sake of simplicity only a simple lighting system installed in a single room will be described in the detailed description, although the lighting system may include more light sources, include adjacent rooms etc.

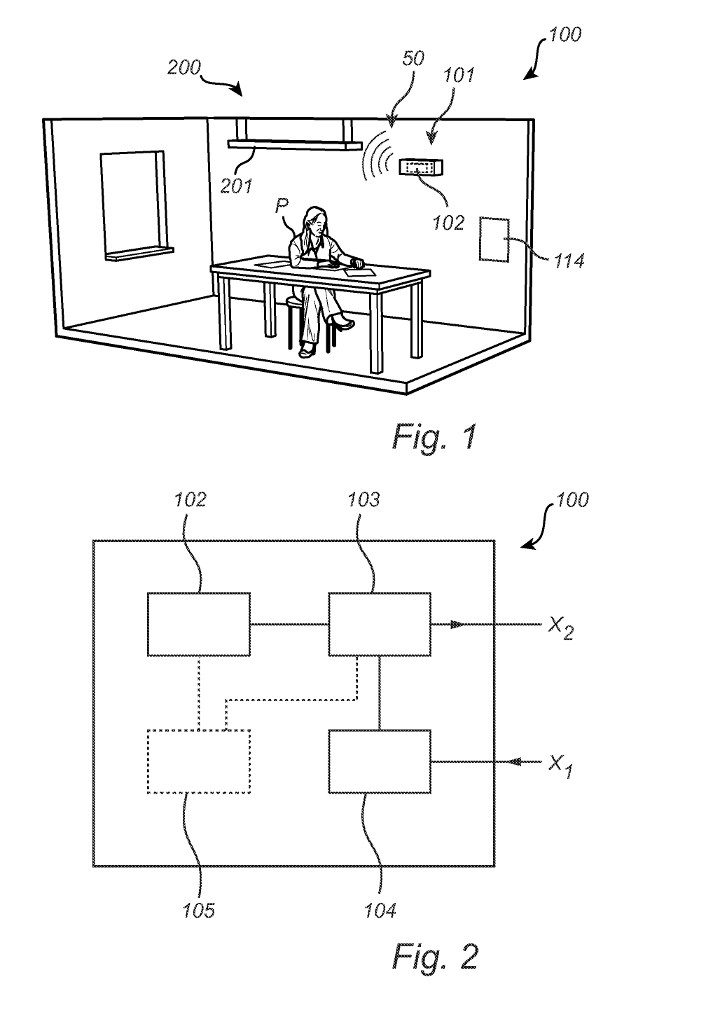

FIG. 1 is a schematic illustration of an area, such as a room 50, in which an occupancy detection system 100 according to the present invention is installed. The occupancy detection system 100 comprises a movement detector 101 having a movement sensor 102 for providing a signal corresponding to movements of an occupant P of the room. Here the movement detector 101 is arranged on a wall of the room 50. Further, a control panel 114 (optional) of the occupancy detection system 100 is arranged on the wall, such that a user can alter the settings of occupancy detection parameters, like for instance delay settings of the occupancy detection system 100. In a typical setting, when the occupant P moves, the movement sensor 102 registers the movement and provides a signal to an occupancy estimator 103, see FIG. 2, which is arranged to estimate an occupancy state of the room to be ‘empty’ or ‘occupied’ based on the signal. In this exemplifying embodiment, the occupancy detection system 100 is used within a presence controlled lighting system 200. The presence controlled lighting system 200 comprises a control unit (not shown) arranged for controlling at least a light source of the room, here a luminaire 201, based on the occupancy state provided by the occupancy detection system 100. In a simple example, when the occupancy state is set to ‘empty’ the luminaire 201 should be turned off, and when the occupancy state is set to ‘occupied’ the luminaire 201 should be turned on. Other types of operations of the light sources which is controlled by the presence controlled lighting system may include adapting the light intensity and color temperature, altering the (number of) active light sources etc.

The movement sensor is here a pyro-electric infrared (PIR) sensor, but other movements sensors based on like for instance radio direction and ranging (RADAR), sound navigation and ranging (SONAR) etc. are applicable in the present inventive concept. In an embodiment of the invention, the movement sensor is arranged to provide a binary signal upon which the analysis is performed. However, in case of an analog system, the analog signal may be converted to a digital, or alternatively be used directly. Multiple movement sensors may be included in the occupancy detection system, but this is not required.

Referring now to FIG. 2 which is a schematic illustration of an embodiment of the occupancy detection system, the occupancy detection system 100 comprises the movement sensor 102 which is operably connected to the occupancy estimator 103, and an input 104 operably connected to the occupancy estimator 103 (optional). The occupancy estimator comprises a signal processor for analyzing the signal from the movement signal, and is further arranged to generate the occupancy state of the room based on detection of a leave pattern in the signal. The leave pattern is a pattern used for determining if an occupant leaves the area where the occupancy sensor 102 is installed by analyzing and determining if the leave pattern is present in the signal from the movement sensor 102. Exemplifying embodiments of a method of determining occupancy of a room is described in more detail herein under.

To continue, via the input 104 occupancy detection parameters associated with a leave pattern and/or the setting of the occupancy state (X₁ in FIG. 2) may be received from a user, e.g. via the control panel 114 shown in FIG. 1, or from an external data base. The occupancy state generated by the occupancy estimator 103 can be communicated to for instance a presence controlled system, like the lighting system 200 in FIG. 1, via an output (X₂ in FIG. 2).

The occupancy detection system 100 optionally comprises storage means 105 for storing occupancy detection parameters, and presence data.

The occupancy detection system 100 is in an embodiment integrated in the movement detector 101. Alternatively at least parts of the occupancy detection system are externally arranged, e.g. the occupancy estimator firmware/hardware may form part of a central control unit of the building in which the occupancy detection system is arranged (not shown).

### Method of Determining Occupancy of a Room

According to an embodiment of the method of determining occupancy of a room, a signal from at least one movement sensor positioned in the room is received and variations in the signal which correspond to movements of an occupant of the room are detected. The detected variations are analyzed in order to identify one or more patterns in the signal. If any identified pattern in the signal corresponds to a leave pattern, which is a predetermined pattern which has been associated with an occupant leaving the room, then the room is determined to be empty, i.e. a leave (leave detection, LD) occurs. The leave pattern may be associated with an occupant leaving the room by means of performing empirical studies, simulations etc.

The leave pattern is according to an embodiment of the method, based on detecting a minimum amount of movement within a predetermined maximum time period LT. The maximum time period LT is defined as a time period of a definite length occurring just before a last detected movement in the room. If a leave pattern corresponding to a minimum amount of movement within the time period LT is identified within the maximum time period LT, a leave LD is detected and the room is determined to be empty. Since the room is determined to be empty, an occupancy state may correspondingly be set to ‘empty’. The setting of the occupancy state may in embodiments further be governed by occupancy detector settings, like for instance predetermined delays etc. The parameters of the LD algorithm as described above can be calibrated in such a way that the occurrence of false detections resulting in an occupancy state set to “occupied” (i.e. lights staying on when the room is empty, ending up in energy waste) is minimized.

According to an embodiment of the method, the minimum amount of movement is based on detecting a minimum number NM of consecutive signal rising or falling edges within the maximum time period LT.

According to an embodiment of the method, the minimum amount of movement is based on detecting a minimum amount of time, a threshold time TH, when the signal indicates movement within the maximum time period LT. For instance, when utilizing a binary signal (‘low’, ‘high’), the signal is analyzed within the time period LT before a last detected movement. If the amount of time T_{high} the signal is ‘high’ is larger than the threshold time TH, a leave LD is detected.

The method as previously described provides an LD algorithm which is based on the output of a movement sensor 102 inside a room 50. In order for the occupancy state of the room 50 to be signaled as ‘empty’, according to an embodiment of the method, two conditions must be met contemporarily: a definite period of time, defined by a first delay T1, has elapsed after the last movement was recorded in the room 50, and a leave LD must be detected immediately before the last movement was recorded. The room is signaled as ‘occupied’ whenever any of these two conditions is not met. Further, if after a last detected movement in the room is recorded, no movement is detected when a definite period of time defined by a second delay T2 has elapsed, independent of the last motion pattern detected, the occupancy state is set to ‘empty’. Preferably, the second delay T2 is selected to be greater than T1. This helps to reduce the energy waste due to the unlikely event of an “occupied” false detection.

The user can set the sensitivity of the LD algorithm: the lower the sensitivity of the algorithm, the lower the occurrence of ‘empty’ false detections, and the higher the occurrence of ‘occupied’ false detections, and vice versa.

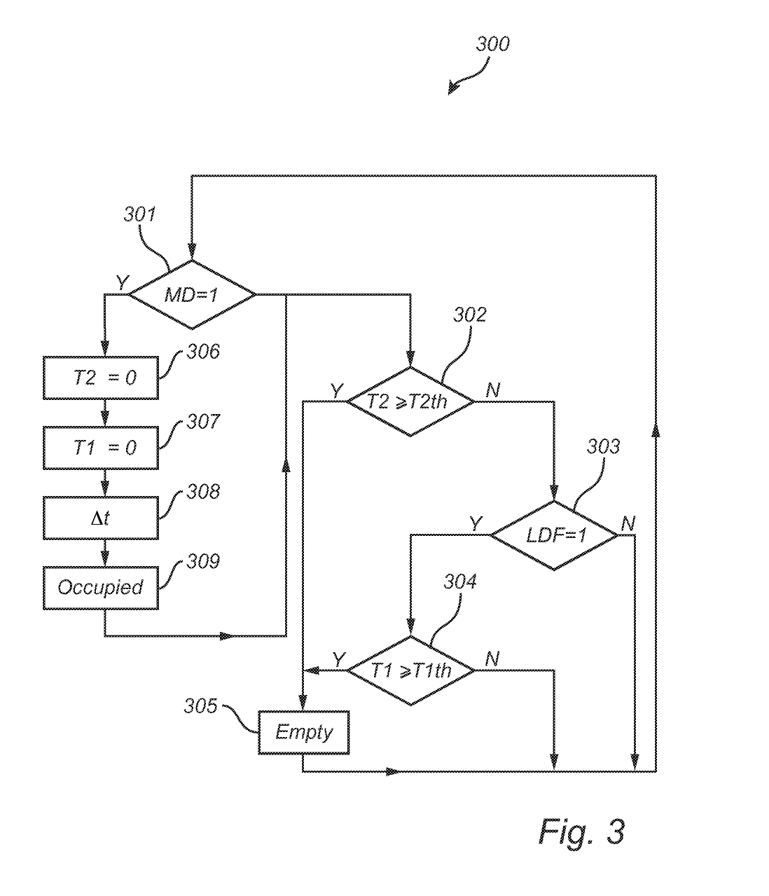

FIG. 3 depicts a flow chart of performing an embodiment of the method of determining occupancy according to the present invention. According to this embodiment of the method, an occupancy detection algorithm (ODA) involves the usage of two timers, T1 and T2, running continuously. Each timer has its own time target, T1ₜₕ and T2ₜₕ, respectively. Each timer also has an output flag that is set to 1 when the time target is reached. In step 301, in FIG. 3, any movement detected (MD=1) by the sensor resets either one of the T1 and the T2 timers, step 306 and step 307. The two timers are neither stopped nor reset when the time target is reached. The ODA decides whether the room is ‘occupied’ or ‘empty’ and communicates this to the presence controlled system, e.g. to drivers of the actuators (luminaries, HVAC etc.) via an occupancy detection flag (ODF) (not shown), whose binary value is 0 or 1 for the occupancy state of the room being set to ‘empty’ or ‘occupied’, respectively.

The ODA makes use of the leave detection algorithm, LD algorithm. As previously described, the LD algorithm decides whether the last movements detected by the sensors are referable to an occupant leaving the room, i.e. a leave LD is detected. The LD algorithm communicates a detected leave LD to the ODA via a leave detection flag (LDF), whose binary value is 0 or 1 if a leave IS NOT or IS detected, respectively.

As an example, the LD is here based on the minimum number of consecutive movements for leave detection NM, and the maximum period over which NM movements must be detected by the sensors for the leave of an occupant to be detected LT. The LD algorithm makes use of a queue structure. In this queue, the time interval between the last two movements detected is stored according to the FIFO strategy. The maximum number of elements stored in the queue is NM. The leave of an occupant is detected (LDF set to 1) whenever the sum of the NM elements of the queue is less than LT, and vice versa. This means that the leave of an occupant is detected if NM movements are detected within LT. Moreover, after the leave of an occupant has been detected (LDF transition from 0 to 1) the ODA blocks any operation for a predetermined amount of time, in order to avoid possible errors due to spurious movements (e.g. reopening the door to check for something).

The ODA algorithm decides whether the room is ‘occupied’ or ‘empty’ according to the following strategy:

If no movement is detected in step 301, and if T2 has elapsed, T2>T2ₜₕ in step 302, the room is signaled as ‘empty’ (ODF set to 0), regardless of the value of LDF, step 305. In step 302, if T2 has not elapsed, it is checked if LDF=1 AND T1 has elapsed, step 303 and 304, the room is signaled as ‘empty’ (ODF set to 0), step 305.

In step 303, if LDF=0 OR T1 has not elapsed, step 304, the room is signaled as ‘occupied’ (ODF set to 1), step 301.

Since the LDA cannot distinguish between the leave or the entrance of an occupant, or other movement detection patterns, such as an occupant moving around in the room, due to the coarseness of the binary signal of the PIR sensors, it is necessary to use the LDA in combination with the T1 timer as described above in order to provide a more reliable outcome.

According to an embodiment of the invention, the method as described above with reference to FIG. 3 is implemented in a lighting and ventilation system. As an example of the presence controlled operation of the lighting and ventilation system, when the lighting controller sends the ‘occupied’/‘empty’ room information (i.e. the value of ODF) either to the luminaries or to the ventilation controller, the outcome is the following:

Room ‘occupied’: luminaries and ventilation are switched ON

Room ‘empty’: lights are switched off and ventilation rate set to minimum level.

According to an embodiment, the light controller may be arranged with a rotary or slider control (not shown) for the sensitivity of the LD algorithm: the lower the sensitivity, the lower the occurrence of “EMPTY ROOM” false detections, the higher the occurrence of “OCCUPIED ROOM” false detections, and vice versa. This one slider control, which is set by the user, directly determines NM, LT and the delay value of T1 within correspondent predetermined ranges that cannot be changed by the user. The delay value of T2 is predetermined and cannot be changed by the user.

The threshold values governing the detection of a leave LD, for instance the minimum number NM, the maximum time period LT, and the threshold time TH, and the delay values T1 and T2, governing the LD algorithm, are examples of occupancy detector settings which may be provided to the occupancy detector system by a user, from a database, or which may be tuned in automatically which described in more detail below.

According to an embodiment, the method further comprises detecting any switch of the occupancy state from an occupied state ‘occupied’, to and an empty state ‘empty’, and for each switch detected over time: recording at least one occupancy detection parameter related to the switch of the occupancy state, and processing the at least one occupancy detection parameter in order to reduce the probability of failure of the method for detecting occupancy. As an exemplifying embodiment, the occupancy detection algorithm ODA is initially set to run as described above. The initial values of the occupancy detection parameters are set according to standard defaults (e.g. T1ₜₕ=15 min, T2ₜₕ=60 min, NMₜₕ=6, LTₜₕ=5 s, where the subscript ‘th’ indicates a threshold). Further, the lighting system 200 has data storage and analysis capabilities that can be deployed either locally (e.g. inside the room controller) or at floor/building level (e.g. inside floor controllers or Building Management System). Every time that the room 50 goes from being signaled ‘occupied’ to being signaled ‘empty’ (i.e. when the lights are switched off), a row is added to the main table of the data storage system. Each row has the following entries:

Timestamp t (time and day of the switch)

T1ₜₕ (time period to switch off the lights after a leave LD is detected)

T2ₜₕ (time period to switch off the lights after no movement has been detected)

NMₜₕ (minimum number of consecutive movements detected for leave LD to be detected)

LTₜₕ (maximum time interval between the first and the last of the NMT consecutive movements recorded for leave to be detected)

NM (number of consecutive movements detected before the last detection, where 2 movements are consecutive when recorded within a time period of less than 1 s; NM will be at least NM_{T})

LT (time interval between the first and the last of the NM consecutive movements recorded)

Event type (binary flag valued 1 when the room has been signaled as empty due to a detected leave LD and T1 expired and valued 0 when the room has been signaled as empty due to T2 expired)

Gold truth (binary flag valued 0 when a movement is recorded after less than e.g. 10 s from the event of lights switching off, since this implies that the room was occupied and one of the occupants had to wave to have the lights switched on again; the flag is valued 1 otherwise)

At fixed time intervals (e.g. once a day or once a week) a machine learning algorithm is run on the whole or part of the dataset in order to optimize the values of the thresholds for the 4 parameters of the algorithm (T1ₜₕ, T2ₜₕ, NMₜₕ, LTₜₕ). The goal of the optimization is to minimize the occurrence of gold truth events equal to 0, and of event type value 0 events (i.e. lights switched off due to T2 elapsed, which indicates a failure of the leave detection algorithm).
The optimization strategy will take into account the following considerations:

If NM is constantly much higher than NMₜₕ, NM can be safely increased to make the LD algorithm more robust

If LT is constantly much lower than LTₜₕ, LTₜₕ can be safely decreased to make the LD algorithm more robust

If gold truth value 0 AND event type value 1 events happen often, the LD algorithm must be made less sensitive (increase NMₜₕ and/or decrease LTₜₕ) and/or T1ₜₕ must be increased

If gold truth value 0 AND event type value 0 events happen often, T2ₜₕ must be increased (and vice versa if false type 0 events never happen)

If gold truth value 1 AND event type value 0 events happen often, the LD algorithm can be made more sensitive (decrease NMₜₕ and/or increase LTₜₕ).

In order to learn the occupancy detection parameters, one possible method is described herein under. An occupancy detection parameter (NMₜₕ, LTₜₕ T1ₜₕ, or T2ₜₕ) is selected and reduced with e.g. 10%. After letting the system operate for some time T, the percentage of events of type 1 with gold truth 1 for this setting is observed. As long as this has not decreased (too much) the parameter value is continued to be decreased. As soon as the observed percentage of events of type 1 with gold truth 1 starts significantly decreasing, the parameter value is returned to its previous value, and another parameter is selected. When all four occupancy detection parameters have been varied, we select the average of the best k performing settings, and use that. This can be done iteratively to continuously improve the setting, until an optimum setting has been found, or the percentage of ground truth 1 events of type 1 does not change with more than 8% anymore. Obviously, other methods for learning parameters such as e.g. simulated annealing, or other local search techniques can be used as well.

While the invention has been illustrated and described in detail in the drawings and foregoing description, such illustration and description are to be considered illustrative or exemplary and not restrictive; the invention is not limited to the disclosed embodiments.

This invention is appropriate for implementing more accurate lighting control system and a more efficient DCV system by upgrading the control algorithm of lighting controllers based on occupancy detectors. The resulting system ensures higher energy saving with increased customer satisfaction.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

1. A method of determining occupancy of a room, the method comprising:
receiving a signal from at least one movement sensor positioned in the room;
detecting variations in the signal which correspond to movements of an occupant of the room;
analyzing the detected variations in order to identify one or more patterns therein; and
determining that the room is empty if the one or more patterns comprises a leave pattern associated with an occupant leaving the room, based on at least one of:
a first delay T1 after which said occupancy state is set to ‘empty’ if no movement is detected after said leave pattern is detected, and
a second delay T2 after which said occupancy state is set to ‘empty’ if no movement is detected after a last detected movement in the room.

2. A method according to claim 1, wherein said leave pattern is based on detecting a minimum amount of movement within a predetermined maximum time period LT.

3. A method according to claim 2, wherein said minimum amount of movement is based on detecting a minimum number NM of consecutive signal rising or falling edges within said maximum time period LT, or is based on detecting a minimum amount of time TH when said signal indicates movement within said maximum time period LT.

4. (canceled)

5. A method according to claim 1, further comprising detecting any switch of said occupancy state from an occupied state ‘occupied’, to and an empty state ‘empty’, and for each switch detected over time:
recording at least one occupancy detection parameter related to the switch of the occupancy state; and
processing said at least one occupancy detection parameter in order to reduce the probability of failure of the method for detecting occupancy.

6. An occupancy detection system comprising:
at least one movement sensor for providing a signal corresponding to movements of at least one occupant of a room;
an occupancy estimator operably connected to said at least one movement sensor for providing an occupancy state based on said signal; and
an output operably connected to the occupancy estimator to communicate the occupancy state generated by the occupancy estimator;
wherein said occupancy estimator is arranged for analyzing variations in said signal in order to identify one or more patterns therein, and setting said occupancy state to indicate a room monitored by said at least one movement sensor to ‘empty’ based on identifying that said one or more patterns comprises a leave pattern associated with an occupant leaving the room, based on at least one of:
a first delay T1 after which said occupancy state is set to ‘empty’ if no movement is detected after said leave pattern is detected, and
a second delay T2 after which said occupancy state is set to ‘empty’ if no movement is detected after a last detected movement in the room.

7. An occupancy detection system according to claim 6, further comprising an input operably connected to said occupancy estimator for receiving occupancy detection parameters associated with said leave pattern and/or said setting of said occupancy state from a user input or an external data base.

8. An occupancy detection system according to claim 6, further comprising storage means for recording said occupancy state and signal over time, and wherein said occupancy estimator is further arranged for controlling occupancy detection parameters.

9. A lighting system comprising at least one light source, an occupancy detection system according to claim 6, and a lighting controller for controlling the at least one light source based on said occupancy state provided by the occupancy detection system.

10. An HVAC system comprising at least one HVAC unit, an occupancy detection system according to claim 6, and a HVAC controller for controlling the at least one HVAC unit based on said occupancy state provided by the occupancy detection system.
